(19) United States
(12) Patent Application Publication
(10) Pub. No.: US 2011/0134777 A1
(43) Pub. Date: Jun. 9, 2011

(54) SYSTEM AND METHOD FOR TRANSPORTING PACKET IN REAL TIME

(75) Inventor: Heuk Park, Daejoen (KR)

(73) Assignee: Electronics and Telecommunications Research Institute, Daejeon (KR)

(21) Appl. No.: 12/960,403

(22) Filed: Dec. 3, 2010

(30) Foreign Application Priority Data
Dec. 4, 2009 (KR) 10-2009-0119965
Dec. 1, 2010 (KR) 10-2010-0121587

(51) Int. Cl. H04L 12/56; H04L 12/26

(52) U.S. Cl. 370/252; 370/389

(57) ABSTRACT

In order for a packet transporting system to transport packets for service in real time, the system estimates whether the first route for transporting the packet provides the quality of service (QoS) required by the service. If the first route is qualified to provide the QoS for transporting the packet, the system estimates whether the first route group including the first route satisfies the reliability required by the service. If the first route group is disqualified to provide the reliability required by the service, the system searches for the second route different from the first route, adds the second route to the first route group, and estimates whether the updated first route group satisfies the reliability, and if, as a result of the reliability estimation, the updated first route group is qualified to provide the reliability, transports the packet in real time by using the first route group which is comprised of the first route and the second route.

### CROSS-REFERENCE TO RELATED APPLICATION

This application claims priority to and the benefit of Korean Patent Application No. 10-2009-0119965 and No. 10-2010-0121587 filed in the Korean Intellectual Property Office on Dec. 4, 2009 and Dec. 1, 2010, the entire contents of which are incorporated herein by reference.

### BACKGROUND OF THE INVENTION

(a) Field of the Invention

The present invention relates to a system and method for transporting a packet.

(b) Description of the Related Art

With the development of computing technology, the ubiquitous computing age in which many things are connected over a network is coming. For the ubiquitous computing age, communication between the things is emerging as a new demand.

In ubiquitous computing, things actually connected over a network include servers, general-purpose computers such as PCs, mobile terminals or smart phones, and embedded systems built in things, such as electric home appliances or sensors. Such connection of the things over a network is expected to create new services, but also expected to generate traffic having a different demand from traffic generated by conventional services, such as the existing Internet applications, telephone calls, or broadcasting.

For the existing Internet applications, such as World Wide Web (WWW), e-mail, and the file transfer protocol (FTP), transferring data without error is important while delay is not much concern. For this reason, the re-transmission policy is used in the existing Internet applications. For the services conventionally classified as the real time one, such as telephone calls or broadcasting, transfer in real time is a very important requirement, while they are relatively less sensitive to packet errors. Furthermore, since conventional real time services such as telephone calls or broadcasting, are received by a user, they can be provided although a problem occurs in voice or video because of some loss.

However, there are many services requiring strict restrictions on both loss and delay. For example, events in the actual space are sensitive to time. Accordingly, if a control signal or control data is not transferred within a desired time when the operation of a specific device is controlled on the basis of data of a sensor, not only may service not be provided, but also additional problems may be generated.

In particular, there is a possibility that services for controlling devices may cause physical damage because of the characteristic that the services control the physical operation of the device. A vehicle that provides automatic driving by collecting information from sensors in the road and motions of other vehicles can become an example. If information necessary to control the vehicle is lost, the safety of automatic driving will be lowered significantly.

Applications requiring strict real-time communication, such as control, have been implemented only in a single device or over a closed and special network. However, as various devices including sensors are connected through the Internet, it is expected that applications requiring internet connection and hard real time bound at the same time will increase.

In a case where this type of service is provided over a packet network, each packet used may have physical results. Accordingly, the operation of each packet is important. To this end, the packet network has to provide reliability required by a user.

However, equipment of a common packet network has low availability. For example, transport equipments in the lower layer, known to have high reliability, is designed for the availability of 99.999%, but a large scale network, say composed of 1000 or more routers, experiences a link failure almost every day. In case that a protection path exists, transport equipment performs protecting switching within 50 ms., geographical or other restrictions often make it impossible to secure a protection path.

A failure of a node is expected to occur more frequently than the failure of the transport equipment. In this case, a lot of time will be taken for path convergence. However, it is difficult to estimate events in the real space, and services requiring immediacy are difficult to secure the time to check a network condition. If protection switching is generated because of a connection failure, a packet during the protection switching is not delayed as much as the time for switching, but is lost.

Such loss cannot be detected in the existing Internet applications. Loss is actually generated in communication services, but a user typically never perceives such loss. In services of a control form strongly requiring real time, packet loss may not only deteriorate the quality of service, but may also make the service itself impossible. In worse cases, packet loss may result in irreversible loss.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a system and method for transporting packets requiring hard real time bound and high reliability.

According to an exemplary embodiment of the present invention, a method of transporting a packet for service in real time is provided by a packet transporting system, including:
searching for a first route, which may be composed of a group of routes for transporting the packets; estimating whether the retrieved first route provides quality of service (QoS) required by the service for transporting the packet; if, as a result of the QoS estimation, the retrieved first route is estimated to provide the QoS for transporting the packet, creating a first route group including the retrieved first route; estimating whether the created first route group satisfies the reliability value required by the service; if, as a result of the reliability estimation, the first route group is disqualified based on reliability required by the service, searching for a second route which may be comprised of a group of routes and is different from the first route, updating the first route group into an updated first route group including the first route and the second route, and estimating whether the updated the first route group satisfies the required reliability; and if, as a result of the estimation, the updated first route group is qualified by the reliability, transporting the packet in real time by using the first route group which is composed of the first route and the second route.

A packet transporting system for transferring packets for services requiring real time according to another exemplary embodiment of the present invention includes:
a route search unit for searching for at least one route for transporting the packets in real time; a QoS qualification unit for checking whether the at least one route retrieved by the route search unit satisfies Quality of Service for transporting the packet, required by the service; a reliability estimation unit for estimating whether a route group including at least one route qualified by the QoS qualification unit satisfies the reliability value required by the service; a packet transport unit for transporting the packet by using all the routes included in the route group, if, as a result of the reliability estimation, the route group is estimated to satisfy the reliability required by the service; and a route group storage/management unit for managing the route group, and if, as a result of the reliability estimation, the route group is disqualified based on the reliability required by the service, requesting the route search unit to search for a new route.

### BRIEF DESCRIPTION OF THE DRAWINGS

FIG. 1 is an exemplary diagram showing a network according to an exemplary embodiment of the present invention;

FIG. 2 is a configuration diagram showing a packet transporting system according to an exemplary embodiment of the present invention; and

FIG. 3 is a flowchart illustrating a packet transporting method according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the entire specification, unless explicitly described to the contrary, the word “comprise” and variations such as “comprises” or “comprising” will be understood to imply the inclusion of stated elements but not the exclusion of any other elements.

In this specification, a terminal may refer to a mobile station (MS), a mobile terminal (MT), a subscriber station (SS), a portable subscriber station (PSS), user equipment (UE), or an access terminal (AT), and may include some of or all functions of the MS, MT, SS, PSS, UE, or AT.

Hereinafter, a packet transporting system and method according to exemplary embodiments of the present invention are described with reference to the accompanying drawings.

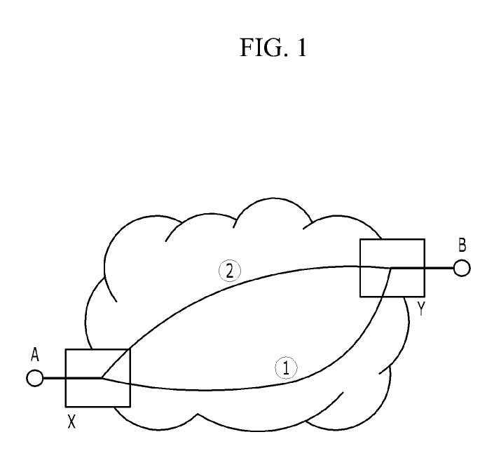

FIG. 1 is an exemplary diagram showing a network according to an exemplary embodiment of the present invention.

As shown in FIG. 1, in case where the reliability value that can be provided by a single route over a network does not satisfy the reliability value required for a real-time service, a predetermined service secures a plurality of routes \textcircled{1} and \textcircled{2} in order to provide desired time delay and quality of service (hereinafter referred to as “QoS”). The predetermined service can secure the reliability required for real-time service by sending the same packet through the plurality of secured routes \textcircled{1} and \textcircled{2}.

That is, the network according to the exemplary embodiment of the present invention is illustrated to have a three-hierarchy structure, chiefly including a service control layer, a network control layer, and a transport network layer. Furthermore, in services requiring a special QoS, a source node and a destination node exchange pieces of information about necessary connection characteristics (e.g., required bandwidth and delay time for the services) through signaling in the service control layer. Here, regarding services and terminals already known in the network, the network may store information for the services when subscribing to the services or at a step after subscribing to the services and use the stored information without additional signaling as occasion demands.

The service control layer transfers the pieces of information exchanged between the nodes to the network control layer. The network control layer converts the pieces of information into necessary network information and sets up the transport network on the basis of the network information. Accordingly, in the network according to the exemplary embodiment of the present invention in which delay and loss are more important than the bandwidth, the network can provide a plurality of routes necessary according to the requirements of services.

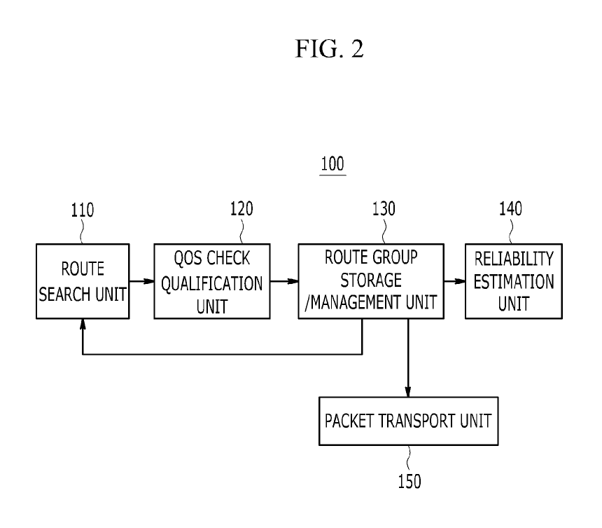

The packet transporting system for satisfying the reliability value required for services as described above is described with reference to FIG. 2. In the exemplary embodiment of the present invention, the hierarchical structure is illustrated to have a system structure, but is not necessarily limited thereto. Furthermore, a case in which the packet transporting system is connected to an additional network is described as an example, but a terminal or a certain sensor may play the role. FIG. 2 is a configuration diagram showing a packet transporting system according to an exemplary embodiment of the present invention.

As shown in FIG. 2, the packet transporting system 100 includes a route search unit 110, a QoS qualification unit 120, a route group storage/management unit 130, a reliability estimation unit 140, and a packet transport unit 150.

In the case where traffic for real-time control is sought to be transmitted from the first terminal to a second terminal, the route search unit 110 searches for the first route between an edge node X to which the first terminal is connected and an edge node Y to which the second terminal is connected. In the case of a wireless terminal, the route search unit 110 may search for a route, separated from a wireless section, by using a plurality of wireless base stations or access points (APs). Here, a route first retrieved may be one route or a plurality of routes. In the exemplary embodiment of the present invention, it is assumed that routes are searched for one by one, for convenience of description.

Next, the QoS qualification unit 120 and the reliability estimation unit 140 estimate QoS and reliability for the retrieved first route. If, as a result of the estimation, either one of the QoS qualification unit 120 and the reliability estimation unit 140 requests the route search unit 110 to search for the second route different from the first route, the route search unit 110 searches for the second route. Here, the route search unit 110 searches for the second route that can satisfy the reliability value required by the service with the smallest number of routes or the lowest cost. A route search method is already known in the art, and a detailed description thereof is omitted in the exemplary embodiment of the present invention.

The reason why two or more routes are searched for as described above is that it enables the transmission of signal or data requiring proper QoS and high reliability even over a network with low reliability since the probability of failure in a plurality of routes is proportional to the product of the probability of failure in each route while the transfer quality of each route is independent of the transfer quality of the other route. In the exemplary embodiment of the present invention, a case in which two routes are searched for and managed as one route group is described as an example, but it is not necessarily limited thereto.

The QoS qualification unit 120 receives information about routes retrieved by the route search unit 110. Next, the QoS qualification unit 120 checks whether the route search unit 110 can satisfy requirements for the QoS including delay required by the service. If, as a result of the QoS estimation, the route retrieved by the search unit 110 is disqualified based on the QoS required by the service, the QoS qualification unit 120 requests the route search unit 110 to search for a new route. However, if, as a result of the QoS estimation, the route retrieved by the search unit 110 is qualified for packet transfer satisfying the QoS including delay required by the service, the QoS qualification unit 120 sends the information about the routes to the route group storage/management unit 130. The route group storage/management unit 130 stores and manages the routes in a route group.

A method of estimating whether the first route satisfies QoS may include a method of determining whether the first route satisfies QoS by measuring the QoS of other packets in the first route and a method of determining whether the first route satisfies QoS by using additional measurement packets. However, in the exemplary embodiment of the present invention, the method of determining whether the first route satisfies QoS is not limited to either one of the two methods.

The method of determining whether the first route satisfies QoS by using additional measurement packets may include a method of finding the loss ratio and delay of the measurement packets, by sending periodically time-stamped measurement packets. The measurement of delay may be performed by measuring absolute delay from a time lag by synchronizing each node, or may be relatively performed on the basis of the delay of the packets that may serve for the reference in the same route.

For example, in a network employing class of service, the packet delay time of a lower class may be measured on the basis of the packet delay time of an upper class. This method is already known in the art, and a detailed description is omitted in the exemplary embodiment of the present invention.

The reliability estimation unit 140 determines whether the route group, stored and managed by the route group storage/management unit 130, can satisfy the reliability required by the service, and informs the route group storage/management unit 130 of the result of the estimation. In the case that only the first route has been retrieved, the route group includes only the first route. However, if, as a result of the estimation by the reliability estimation unit 140, the route group is disqualified for the packet transfer not satisfying the reliability required by the service, the route group storage/management unit 130 requests the route search unit 110 to search for a new route.

A method of collecting history information of all nodes on an established route and estimating reliability on the basis of the history information may be used as a method of the reliability estimation unit 140 estimating whether a group including one or more routes satisfies reliability required by service. Furthermore, the method of the reliability estimation unit 140 estimating whether a group including one or more routes satisfies the reliability value required by the service may be performed by using reliability presented by the equipments for all nodes on the route, but is not necessarily limited to any one method.

If the route group including the routes retrieved by the route search unit 110 satisfies the reliability required by the service, the route group storage/management unit 130 transfers the configured route group to the packet transport unit 150, thereby completing a packet transport route configuration. That is, if the route group including the first route satisfies the reliability required by the service, the route group storage/management unit 130 terminates the configuration of the route group with the search for the first route, and the packet transport unit 150 transports a packet by using only the first route, thereby providing the service.

However, if the route group including the first route does not satisfy the reliability required by the service, the route group storage/management unit 130 requests the route search unit 110 to search for a new route. The second route retrieved by the route search unit 110 as a route independent of the first route is qualified to provide the QoS requested by the service like the first route. If the second route passes the QoS qualification, it is stored in the route group including the first route, and thus the route group is updated.

Next, the route group storage/management unit 130 requests the reliability estimation unit 140 to estimate the reliability for the updated route group. If, as a result of the reliability estimation by the reliability estimation unit 140, the updated route group is qualified to provide the reliability required by service, the updated route group is transferred to the packet transport unit 150 so that the service is initiated. However, if, as a result of the estimation by the reliability estimation unit 140, the updated route group fails to pass the reliability criteria required by the service, the process returns to the step of searching for a new route.

In a route group composed of a plurality of routes which are configured not to overlap each other, the probability of failure for the route group is equal to the product of the possibility of failure of each route. Reliability of the route group can be estimated from the failure probability of the route group.

The route group storage/management unit 130 groups pieces of information about routes qualified to provide the required QoS by the QoS estimation unit 120, from among routes retrieved by the route search unit 110, as a route group, and stores and manages the route group. In the exemplary embodiment of the present invention, it is assumed that two routes, the first route and the second route, are managed as a group. A route group including the first route is referred to as the first route group, and a route group including the first route and the second route is referred to as the updated first route group.

The route group storage/management unit 130 may check the QoS and the reliability of a route group on the basis of the information about the first route group periodically or according to network conditions. The route group storage/management unit 130 may update the route group as occasion demands, such as a case in which quality and reliability of the route group do not satisfy the values required by the service, according to network conditions, and informs the packet transport unit 150 of the updated route group. The route group is updated as occasion demands, and the route group update procedure is not necessarily performed.

If the reliability estimation unit 140 estimates whether the updated first route group satisfies the reliability required by the service, the packet transport unit 150 sends a control signal or control data, received from the first terminal, to the second terminal by using the first route and the second route retrieved by the route search unit 110.

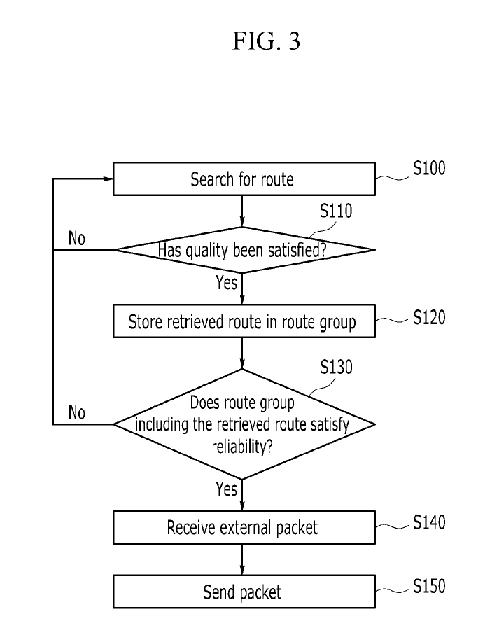

A method of transferring the packets through the packet transporting system constructed as above is described below with reference to FIG. 3. To this end, it is assumed that the second terminal requests data having real-time characteristic from the first terminal, and the packet transporting system 100 searches for a route and sends the data to the second terminal using the retrieved route.

FIG. 3 is a flowchart illustrating a packet transporting method according to an exemplary embodiment of the present invention.

As shown in FIG. 3, when the second terminal requests the data with real-time characteristic, the route search unit 110 of the packet transporting system 100 searches for a route between the first terminal and the second terminal at step S100. Here, it is assumed that a route first retrieved by the route search unit 110 is the first route and the first route satisfies the quality required by the service, but the first route group including the first route does not satisfy reliability required by the service.

The QoS qualification unit 120 first estimates whether the first route retrieved by the route search unit 110 satisfies the QoS including delay required by the service at step S110. Here, the QoS estimation method may be performed by measuring the quality of another packet existing in the first route, or may be performed by using additional measurement packets. In the exemplary embodiment of the present invention, the QoS estimation method is not limited to either one of the two methods.

If, as a result of the QoS qualification at step S110, the first route is disqualified to provide the QoS including delay, the QoS Qualification unit 120 requests the route search unit 110 to search for a route different from the first route.

However, if, as a result of the QoS qualification at step S110, the first route is qualified to satisfy the QoS including delay, the QoS Qualification unit 120 transfers information about the first route to the route group storage/management unit 130. The route group storage/management unit 130 stores the first route in the first route group and manages the first route group at step S120. Next, the route group storage/management unit 130 requests the reliability estimation unit 140 to estimate whether the first route group including only the first route provides the reliability required by the service at step S130.

Here, a method of collecting history information about all nodes on a route and estimating reliability on the basis of the history information may be used as a method of determining the reliability of a route group including a single route. Alternatively, a method using reliability announced by the equipments in all nodes on the route may be used as the method of determining the reliability of a route group including a single route, but it is not necessarily limited to any one method.

It has been assumed that the first route group including only the first route does not satisfy the required reliability. Accordingly, the reliability estimation unit 140 transfers the result, indicating that the reliability has not been satisfied, to the route group storage/management unit 130. In response thereto, the route group storage/management unit 130 requests the route search unit 110 to search for another route different from the first route.

In response to the request, the route search unit 110 searches for a new route, the second route, different from the first route. Here, it is assumed that the second route satisfies the quality required by the service.

The QoS qualification unit 120 qualifies whether the second route retrieved by the route search unit 110 provides the quality required by the service at step S110. If, as a result of the QoS qualification at step S110, the second route is determined to satisfy the quality, the route group storage/management unit 130 stores information about the second route in the first route group including the first route at step S120. Furthermore, the first route group is generated as an updated first route group.

Next, the route group storage/management unit 130 requests the reliability estimation unit 140 to estimate whether the updated first route group consisting of the first route and the second route satisfies the reliability required by the service at step S130. If, as a result of the reliability estimation at step S130, the updated first route group is disqualified based on the reliability required by the service, the reliability estimation unit 140 informs the route group storage/management unit 130 that the updated first route group satisfies the desired reliability.

Here, the reliability of the updated first route group can be calculated on the basis of reliability estimated from each of the first and second routes. If the updated first route group satisfies the reliability required by the service, the route group storage/management unit 130 terminates the configuration of the updated first route group. Next, the route group storage/management unit 130 informs the packet transport unit 150 of the information about the updated first route group. Accordingly, when the transmission of packets is subsequently requested, the packet transport unit 150 can send the packets by using both the first route and the second route.

However, if, as a result of the reliability estimation at step S130, the updated first route group is disqualified based on the reliability required by the service, the route group storage/management unit 130 requests the route search unit 110 to search for a new route different from the second route. Next, the procedure after step S110 is performed.

Through the above procedure, the updated first route group consisting of the first route and the second route is configured. If the first route group satisfies the reliability required by the service, the route group storage/management unit 130 transfers the information about the first route group to the packet transport unit 150. The route group storage/management unit 130 may check the quality and the reliability of a route group on the basis of the information about the first route group periodically or according to network conditions, update the route group as occasion demands, and inform the packet transport unit 150 of the updated route group.

When packets to be transported are received from a terminal or another system at step S140, the packet transport unit 150 transports the packet by using the route group composed of a plurality of qualified routes, say the first route and the second route in the exemplary embodiment, on the basis of the information about the first route group received from the route group storage/management unit 130 at step S150.

According to the exemplary embodiments of the present invention, in case where service is hindered by small packet loss, a plurality of routes satisfying the QoS required by the service in a network are searched for, a packet is replicated, and the replicated packets are transported. Accordingly, not only can reliability required by the service be increased, but also stability of the service can be improved because the routes satisfying the quality and reliability required by the service can be secured.

If a route group for the data packets for service is provided as described above, the failure ratio of a route group consisting of two routes is the product of the failure ratio of each route. Accordingly, the data packet can be provided with the reliability required by the service. Furthermore, the stability of the service may be improved.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of transporting a packet for service in real time by a packet transporting system, the method comprising:
searching for a first route which is comprised of at least one route for transporting the packet;
estimating whether the retrieved first route provides quality of service (QoS) for transporting the packet, required by the service;
if, as a result of the QoS estimation, the retrieved first route is qualified to provide the QoS for transporting the packets, creating a first route group including the retrieved first route;
estimating whether the created first route group satisfies reliability required by the service;
if, as a result of the reliability estimation, the first route group is estimated not to satisfy the reliability required by the service, searching for a second route which is comprised of at least one route different from the first route, updating the first route group to an updated first route group including the first route and the second route, and determining whether the updated first route group satisfies the reliability; and
if, as a result of the reliability estimation, the updated first route group is estimated to satisfy the reliability, transporting the packet in real time by using the updated first route group containing the first route and the second route.

2. The method of claim 1, further comprising transporting the packet by using only the retrieved first route, if, as a result of the reliability estimation, the first route group is estimated to satisfy the reliability required by the service.

3. The method of claim 1, wherein estimating whether the updated first route group satisfies the reliability comprises:
searching for the second route different from the first route;
estimating whether the retrieved second route provides the QoS, required by the service;
if, as a result of the QoS estimation, the retrieved second route is qualified to provide the QoS required by the service, creating the updated first route group by storing the second route and the first route in the first route group; and
estimating whether the updated first route group satisfies the reliability.

4. The method of claim 3, further comprising searching for a different route from the second route, if, as a result of the QoS estimation, the retrieved second route is disqualified to provide the QoS required by the service.

5. The method of claim 1, wherein the creating of a first route group further includes
if, as a result of the QoS estimtation, the retrieved first route is disqualified to provide the QoS for transporting the packet:
searching for another route different from the retrieved first route;
estimating whether the searched route satisfies the quality for transporting the packet; and
including the searched route into the first route group if the searched route satisfies the quality for transporting the packet.

6. A packet transporting system for transferring packets for the service in real time, comprising:
a route search unit for searching for at least one route for transporting the packet in real time;
a QoS qualification unit for estimating whether the at least one route retrieved by the route search unit satisfies quality required by the service for transporting the packet;
a reliability estimation unit for estimating whether a route group including the at least one route estimated to satisfy the quality by the QoS qualification unit satisfies reliability required by the service;
a packet transport unit for transporting the packets by using at least one route included in the route group, if, as a result of the reliability estimation, the route group is estimated to satisfy the reliability required by the service; and
a route group storage/management unit for managing the route group, and if, as a result of the reliability estimation, the route group is estimated not to satisfy the reliability required by the service, requesting the route search unit to search for a new route.

7. The system of claim 6, wherein the route group storage/management unit stores information about a route satisfying the quality required by the service, from among the at least one route retrieved by the route search unit, in the route group, and manages the route group, if the route group including the new route is updated to an updated route group, requests the reliability estimation unit to estimate the reliability of the updated route group, and sends information about the updated route group on which the reliability qualification has been completed to the packet transport unit.

8. The system of claim 6, wherein the QoS qualification unit requests the route search unit to search for a new route, if the at least one route retrieved by the route search unit does not satisfy the quality.

9. The system of claim 8, wherein the packet transport unit transports the packet by using each of a plurality of routes when the plurality of routes are retrieved by the route search unit.
